(19) United States
(12) Patent Application Publication
(10) Pub. No.: US 2025/0279842 A1
(43) Pub. Date: Sep. 4, 2025

(54) ARTIFICIAL NOISE (AN) CANCELATION

(71) Applicant: QUALCOMM Incorporated, San Diego, CA (US)

(72) Inventors: Yavuz YAPICI, Florham Park, NJ (US); Tao LUO, San Diego, CA (US); Igor GUTMAN, Hod HaSharon, Haifa District (IL); Junyi LI, Greentown, PA (US)

(21) Appl. No.: 18/863,617

(22) PCT Filed: Jul. 14, 2023
(86) PCT No.: PCT/US2023/070283

§ 371 Date: Nov. 6, 2024

(30) Foreign Application Priority Data
Jul. 24, 2022 (IL) 294993

(51) Int. Cl. H04K 1/02; H04B 7/06; H04K 1/10

(52) U.S. Cl. CPC H04K 1/025; H04B 7/0617; H04K 1/10

(57) ABSTRACT

Certain aspects relate to techniques for canceling artificial noise via spatial processing. For example, artificial noise may be added to a transmission of a legitimate signal to conceal the legitimate signal from an unintended receiver. Aspects described herein relate to cancelation of artificial noise that has been added to physical layer transmissions. For example, a first wireless node may transmit a first transmission comprising a first artificial noise signal combined with a first data signal, and a second transmission comprising a second artificial noise signal. Due to the spatial differences in the first transmission and the second transmission, the artificial noise signals may zero out after being soft-combined by the receiving device.

### CROSS-REFERENCE TO RELATED APPLICATION(S)

This application claims the benefit of Israel Patent Application Serial No. 294993, entitled “ARTIFICIAL NOISE (AN) CANCELATION” and filed on Jul. 24, 2022, which is incorporated herein by reference in its entirety.

### TECHNICAL FIELD

The present disclosure generally relates to communication systems, and more particularly, to techniques for canceling artificial noise in wireless communications.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some aspects of wireless communication include direct communication between devices, such as device-to-device (D2D), vehicle-to-everything (V2X), and the like. There exists a need for further improvements in such direct communication between devices. Improvements related to direct communication between devices may be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to a first wireless node configured for wireless communication. In some examples, the first wireless node includes one or more memories, and one or more processors each communicatively coupled with at least one of the one or more memories. The one or more processors, individually or in any combination, are operable to cause the first wireless node to transmit, to a second wireless node via a first channel, a first transmission comprising a first artificial noise (AN) signal combined with a first data signal, wherein the first AN signal is generated based on channel state information (CSI) of the first channel. In some examples, the one or more processors, individually or in any combination, are operable to cause the first wireless node to transmit, to the second wireless node via a second channel, a second transmission comprising a second AN signal, wherein the second AN signal is generated based on CSI of the second channel, and wherein the first transmission and the second transmission overlap in time.

Certain aspects are directed to a method for wireless communication by a first wireless node. In some examples, the method includes transmitting, to a second wireless node via a first channel, a first transmission comprising a first artificial noise (AN) signal combined with a first data signal, wherein the first AN signal is generated based on channel state information (CSI) of the first channel. In some examples, the method includes transmitting, to the second wireless node via a second channel, a second transmission comprising a second AN signal, wherein the second AN signal is generated based on CSI of the second channel, and wherein the first transmission and the second transmission overlap in time.

Certain aspects are directed to a first wireless node. In some examples, the first wireless node includes means for transmitting, to a second wireless node via a first channel, a first transmission comprising a first artificial noise (AN) signal combined with a first data signal, wherein the first AN signal is generated based on channel state information (CSI) of the first channel. In some examples, the first wireless node includes means for transmitting, to the second wireless node via a second channel, a second transmission comprising a second AN signal, wherein the second AN signal is generated based on CSI of the second channel, and wherein the first transmission and the second transmission overlap in time.

Certain aspects are directed to one or more non-transitory computer-readable media having instructions stored thereon that, when executed by one or more processors of a first wireless node, cause the one or more processors of the first wireless node to, individually or in combination, perform operations. In some examples, the operations include transmitting, to a second wireless node via a first channel, a first transmission comprising a first artificial noise (AN) signal combined with a first data signal, wherein the first AN signal is generated based on channel state information (CSI) of the first channel. In some examples, the operations include transmitting, to the second wireless node via a second channel, a second transmission comprising a second AN signal, wherein the second AN signal is generated based on CSI of the second channel, and wherein the first transmission and the second transmission overlap in time.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4 is a block diagram illustrating an example monolithic (e.g., aggregated) base station and architecture of a distributed radio access network (RAN), in accordance with various aspects of the present disclosure.

FIG. 5 is a block diagram illustrating an example disaggregated base station architecture, in accordance with various aspects of the present disclosure.

FIG. 6 includes a diagram conceptually illustrating an example RAN as well as a schematic illustrating a conceptual RF front-end, in accordance with various aspects of the present disclosure.

FIG. 7 is a schematic conceptually illustrating an example RF front-end, in accordance with various aspects of the present disclosure.

FIG. 8 is a call-flow diagram illustrating example communications between a first wireless node and a second wireless node, in accordance with various aspects of the present disclosure.

FIG. 9 is a flowchart illustrating an example method of wireless communication, in accordance with various aspects of the present disclosure.

FIG. 10 is a diagram illustrating an example of a hardware implementation for an example apparatus, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Security is an important aspect of wireless communications. Since wireless channels are broadcast in nature, any wireless device with radio frequency (RF) capability (e.g., a user equipment (UE)) may potentially eavesdrop or intercept ongoing transmissions or data exchanges. Moreover, in internet of things (IoT) device communications, where a myriad of devices may be connected to each other, the risk to security may be even greater due to the relatively high number of potential data leak points. As a result, preventing eavesdropping or information leakage in wireless communications is of primary importance.

Upper layer communications may be communicated using pre-configured security mechanisms, such as cryptographic functions. However, reference signaling (RS), and information transmitted over physical control channels may be unsecured. As a result, if an eavesdropper were to intercept and modify such control information, the eavesdropper could cause an out-of-service event for the UE or cause a degradation of data throughput. Such an attack could also impair the reliability of wireless communications. Thus, techniques for securing physical (PHY) layer transmissions could improve.

In certain aspects, artificial noise (AN) may be added to PHY layer transmissions to mask a legitimate signal. That is, the AN may prevent an eavesdropping device from properly decoding the legitimate signal, and in some cases, may prevent the eavesdropping device from recognizing PHY layer transmissions at all. As discussed below, the AN may be added to a signal by a transmitter without an impact on time-domain or frequency-domain resources. As such, the AN may be added to any PHY layer communication, including RSs, physical control channels, physical shared channels, physical sidelink channels, etc. It should be noted that the term “channel,” as used herein, may relate to the physical layer communication channel(s) and/or region(s) of a communication channel (e.g., RS regions, control regions, data regions, etc.) to which an AN may be added.

AN is a signal that is transmitted concurrently or added to a legitimate signal to intentionally corrupt the legitimate signal. In some examples, the AN may be generated based on channel state information (CSI) (e.g., channel quality information (CQI)) of a desired recipient. In certain aspects, a CSI reference signal (CSI-RS) may be transmitted by a network node (e.g., a base station or an aspect of a disaggregated base station) to a UE. The UE may use the CSI-RS to estimate channel quality and report the estimated channel quality (e.g., via CQI) back to the network node. The CSI-RS and the reported CSI described throughout this disclosure may be implemented across a broad variety of telecommunication systems, network architectures, and communication standards (e.g., 3^{rd} Generation Partnership Project (3GPP). By designing the AN signals in this manner, the AN aspect of the transmission may be canceled out at the desired recipient after soft-combining spatially separate instances of the transmission.

In certain aspects, a transmitting device (e.g., a base station or UE) may provide security to a PHY layer signal by intentionally impairing a legitimate signal by adding AN in the power domain. That is, the legitimate signal and the AN may use the same precoder. To enable the desired receiver (e.g., another base station or UE) to remove the AN signal, the transmitting device generates multiple copies of the legitimate signal and transmits them by adding a different AN signal to each copy. The transmitting device may then transmit each of these impaired signals simultaneously (e.g., at the same time) using a different beam associated with a unique antenna port. In other words, the AN is spatially designed based on the receivers CSI so that it can be eliminated only by the intended receiver.

The intended receiver may soft-combine the multiple intentionally impaired signals, which eliminates the AN contribution naturally at the receiver since each AN signal is designed using the CSI of the beam (corresponding to the intended receiver) by which it is being transmitted. Soft combining is the process of combining all the received impaired signals, using a statistical algorithm or other means, for use in error recovery. For example, with soft combining, received transmissions are not discarded, but are stored in a buffer instead. By using soft combining, the multiple received transmissions may be combined together to naturally eliminate the AN contribution to each of the transmissions, thereby leaving the legitimate signal to be decoded. It should be noted that by transmitting the multiple impaired transmissions simultaneously, the signal-to-noise ratio of the legitimate signal is improved relative to a single transmission.

An eavesdropping device cannot recover the legitimate signal because the eavesdropping device is in a different location. Accordingly, the spatial dimensions of the transmissions may not be eliminated by the eavesdropping device even with soft combining of the multiple signals.

In some examples, the transmitting device may choose a relatively large rate for error-correcting code associated with each message in order to use fewer frequency resources. In such an example, the decrease in error performance in decoding the message may be offset by an increase in the SNR value due to the soft combining of the multiple impaired signals. For example, instead of setting an aggregation level (AL) to 2 for transmissions, the transmitting device may transmit the signal with AN using two beams where AL is set to 1. It should be noted that the increased SNR at the intended receiver after soft combining the multiple transmissions may also compensate for any transmission power loss due to a relatively high number of simultaneous beams being transmitted under transmit power budget constraints. Eavesdroppers may also be prevented from decoding a legitimate signal from any beam individually since each beam is carrying a low-power message.

In some examples, the transmitting device may adjust a power split between the legitimate signal and the AN signal per retransmission and/or per beam based on: (i) the intended receiver's quality of service (QoS) and security requirements; and/or (ii) a CQI or reported CSI of the intended receiver. For example, the power split may be adjusted based on a tradeoff between secure transmission and throughput of the transmission.

In some examples, the transmitting device may perform beam selection to determine which beams will be used to transmit the AN and legitimate signals. For example, the beam selection may be performed to ensure that each copy of the message is carried by beams that are spatially uncorrelated to each other to benefit from spatial diversity and enhance performance.

In some examples, the confidential messages transmitted on each beam with AN may also be different to improve the multiplexing gain (as opposed to diversity-combining scheme where there is a single confidential message transmitted on each beam). In another example, the transmitting device may use some beams to transmit only an AN signal without any confidential message. Here, if the intended receiver is equipped with multiple antennas, only a subset of receive antennas might be selected to be active.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

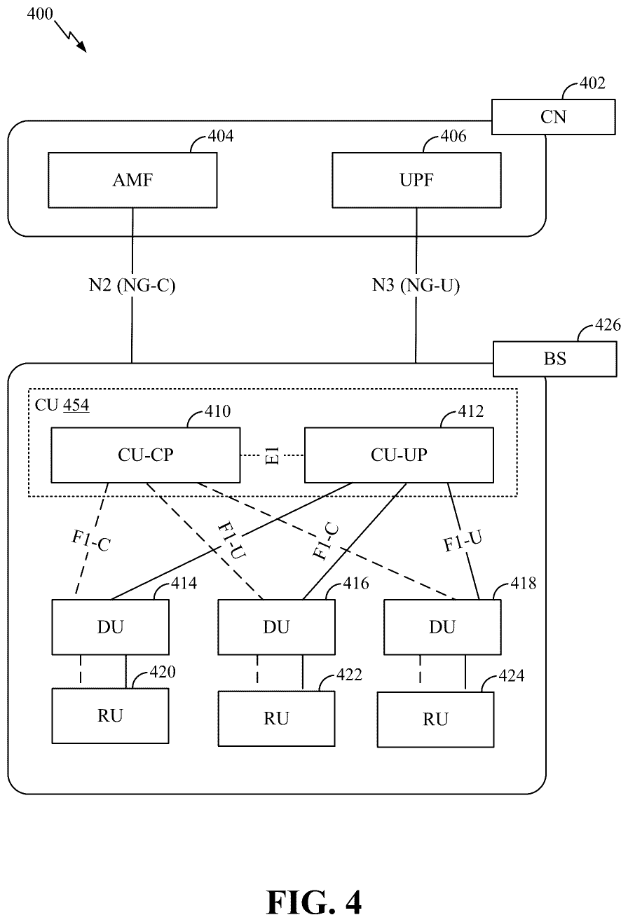

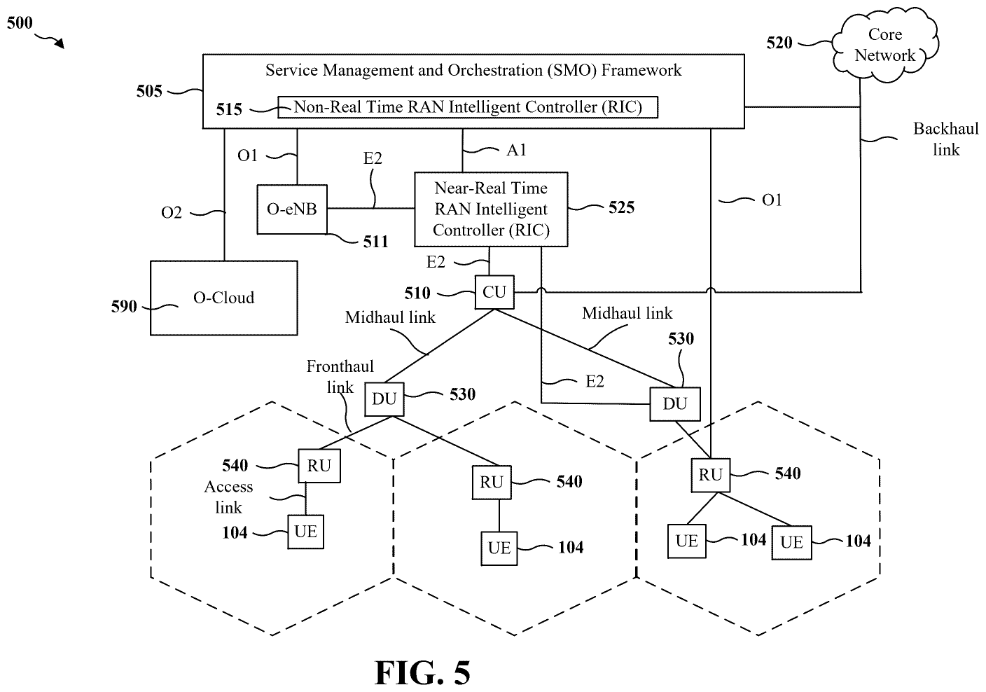

Throughout the disclosure, a “network node” may be used to refer to a base station or a component of the base station. A base station can be implemented as an aggregated base station (e.g., FIG. 4), as a disaggregated base station (e.g., FIG. 5), an integrated access and backhaul (IAB) node, a relay node, etc. Accordingly, a network node may refer to one or more of a central unit (CU), a distributed unit (DU), a radio unit (RU), a near-real time (near-RT) radio access network (RAN) intelligent controller (RIC), or a non-real time (non-RT) RIC. Throughout the disclosure, a “wireless node” may be used to refer to a network node or a UE. For example, a “first wireless node” may describe a first network node in communication with a second network node or a first UE, or the “first wireless node” may describe the first UE in a sidelink communication with a second UE. Accordingly, a “second wireless node” may the second network node or the second UE.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

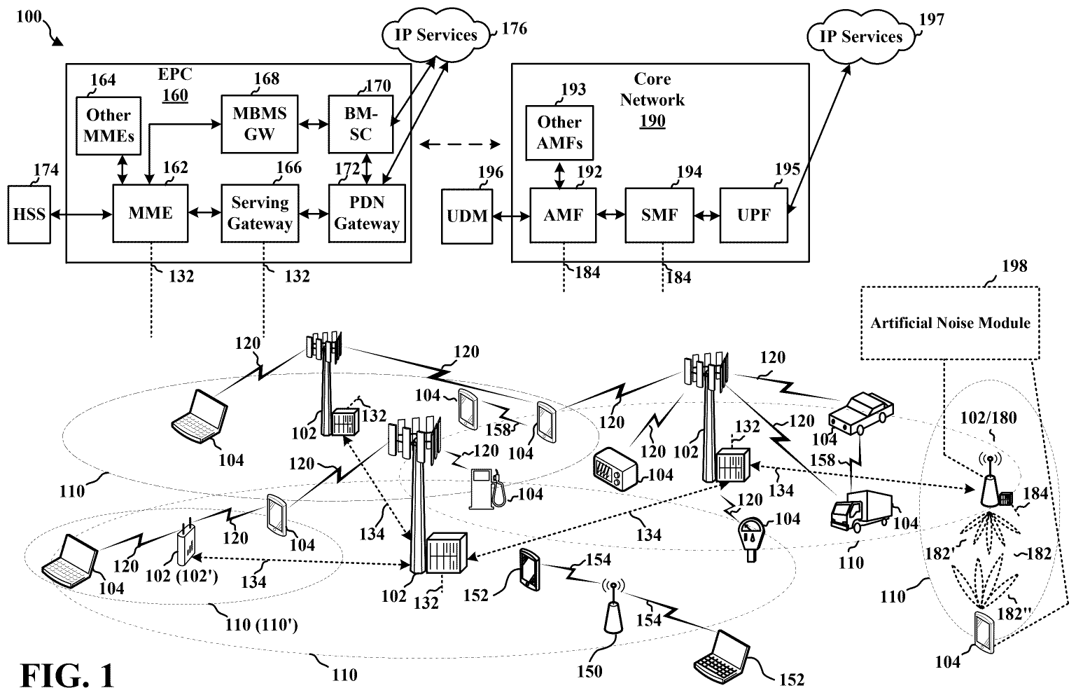

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The present disclosure may also be applicable to vehicle-to-everything (V2X) communications and similar concepts, such as D2D communication, IoT communication, Industrial IoT (IIoT) communication, and/or other standards/protocols for communication in wireless/access networks. Additionally, or alternatively, the concepts and various aspects described herein may be of particular applicability to one or more specific areas, such as vehicle-to-pedestrian (V2P) communication, pedestrian-to-vehicle (P2V) communication, vehicle-to-infrastructure (V2I) communication, and/or other frameworks/models for communication in wireless/access networks.

Referring again to FIG. 1, in certain aspects, the UE 104 and/or base station 102/180 (e.g., first wireless node) may include an artificial noise module 198 configured to transmit, to a second wireless node (e.g., another UE 104 and/or another base station 102/180) via a first channel, a first transmission comprising a first artificial noise (AN) signal combined with a first data signal, wherein the first AN signal is generated based on channel state information (CSI) of the first channel; and transmit, to the second wireless node via a second channel, a second transmission comprising a second AN signal, wherein the second AN signal is generated based on CSI of the second channel, and wherein the first transmission and the second transmission overlap in time.

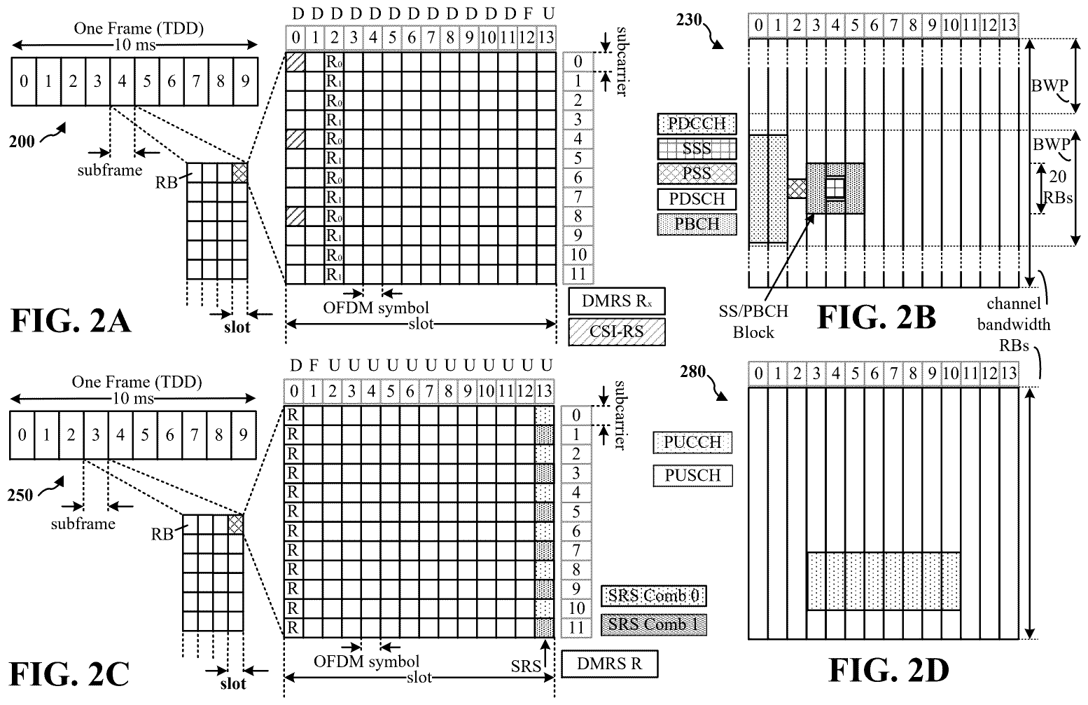

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies p 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2 slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology p=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

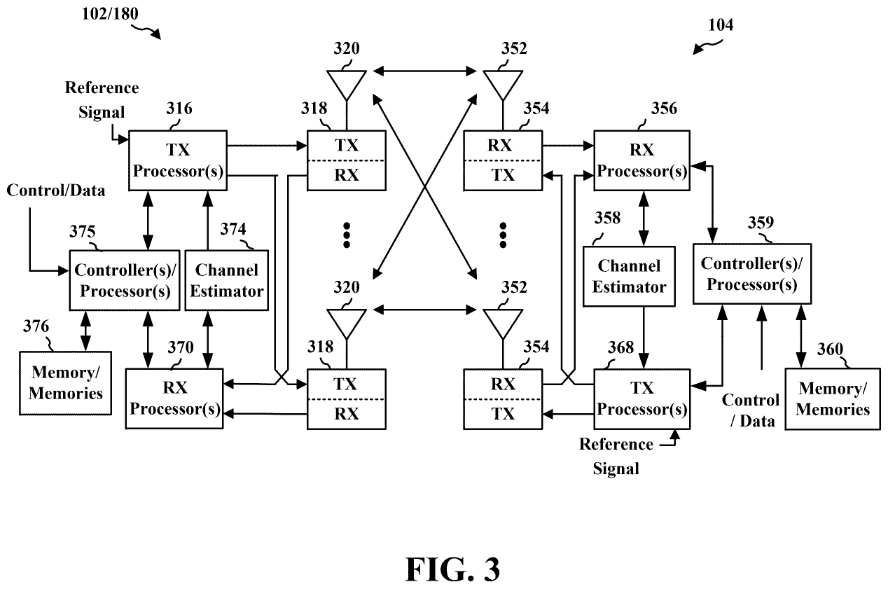

FIG. 3 is a block diagram of a base station 102/180 in communication with a UE 104 in an access network. In the DL, IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the UE 104. If multiple spatial streams are destined for the UE 104, they may be combined by the one or more RX processors 356 into a single OFDM symbol stream. The one or more RX processors 356 then convert the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the one or more controllers/processors 359, which implement layer 3 and layer 2 functionality.

The one or more controllers/processors 359 may each be associated with one or more memories 360 that store program codes and data. The one or more memories 360, individually or in any combination, may be referred to as a computer-readable medium. In the UL, the one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with the DL transmission by the base station 102/180, the one or more controllers/processors 359 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium. In the UL, the one or more controllers/processors 375 provide demultiplexing between transport and logical channels, packet reassembly, deciphering, header decompression, control signal processing to recover IP packets from the UE 104. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359 may be configured to perform aspects in connection with 198 of FIG. 1.

At least one of the one or more TX processors 316, the one or more RX processors 370, and the one or more controllers/processors 375 may be configured to perform aspects in connection with 198 of FIG. 1.

FIG. 4 illustrates an example monolithic (e.g., disaggregated) architecture of a distributed RAN 400, which may be implemented in the wireless communications system and an access network 100 illustrated in FIG. 1. As illustrated, the distributed RAN 400 includes core network (CN) 402 and a base station 426.

The CN 402 may host core network functions. CN 402 may be centrally deployed. CN 402 functionality may be offloaded (e.g., to advanced wireless services (AWS)), in an effort to handle peak capacity. The CN 402 may include an AMF 404 and a UPF 406. The AMF 404 and UPF 406 may perform one or more of the core network functions.

The base station 426 may communicate with the CN 402 (e.g., via a backhaul interface). The base station 426 may communicate with the AMF 404 via an N2 (e.g., NG-C) interface. The base station 426 may communicate with the UPF 406 via an N3 (e.g., NG-U) interface. The base station 426 may include a central unit-control plane (CU-CP) 410, one or more central unit-user planes (CU-UPs) 412, one or more distributed units (DUs) 414-418, and one or more radio units (RUs) 420-424.

The CU-CP 410 may be connected to one or more of the DUs 414-418. The CU-CP 410 and DUs 414-418 may be connected via a F1-C interface. As shown in FIG. 4, the CU-CP 410 may be connected to multiple DUs, but the DUs may be connected to only one CU-CP. Although FIG. 4 only illustrates one CU-UP 412, the base station 426 may include multiple CU-UPs. The CU-CP 410 selects the appropriate CU-UP(s) for requested services (e.g., for a UE). The CU-UP(s) 412 may be connected to the CU-CP 410. For example, the CU-UP(s) 412 and the CU-CP 410 may be connected via an E1 interface. The CU-UP(s) 412 may be connected to one or more of the DUs 414-418. The CU-UP(s) 412 and DUs 414-418 may be connected via a F1-U interface. As shown in FIG. 4, the CU-CP 410 may be connected to multiple CU-UPs, but the CU-UPs may be connected to only one CU-CP 410.

A DU, such as DUs 414, 416, and/or 418, may host one or more TRP(s) (transmit/receive points, which may include an edge node (EN), an edge unit (EU), a radio head (RH), a smart radio head (SRH), or the like). A DU may be located at edges of the network with radio frequency (RF) functionality. A DU may be connected to multiple CU-UPs that are connected to (e.g., under the control of) the same CU-CP (e.g., for RAN sharing, radio as a service (RaaS), and service specific deployments). DUs may be configured to individually (e.g., dynamic selection) or jointly (e.g., joint transmission) serve traffic to a UE. Each DU 414-416 may be connected with one of RUs 420/422/424.

The CU-CP 410 may be connected to multiple DU(s) that are connected to (e.g., under control of) the same CU-UP 412. Connectivity between a CU-UP 412 and a DU may be established by the CU-CP 410. For example, the connectivity between the CU-UP 412 and a DU may be established using bearer context management functions. Data forwarding between CU-UP(s) 412 may be via a Xn-U interface.

The distributed RAN 400 may support fronthauling solutions across different deployment types. For example, the RAN 400 architecture may be based on transmit network capabilities (e.g., bandwidth, latency, and/or jitter). The distributed RAN 400 may share features and/or components with LTE. For example, the base station 426 may support dual connectivity with NR and may share a common fronthaul for LTE and NR. The distributed RAN 400 may enable cooperation between and among DUs 414-418, for example, via the CU-CP 412. An inter-DU interface may not be used. Logical functions may be dynamically distributed in the distributed RAN 400.

FIG. 5 is a block diagram illustrating an example disaggregated base station 500 architecture. The disaggregated base station 500 architecture may include one or more CUs 510 that can communicate directly with a core network 520 via a backhaul link, or indirectly with the core network 520 through one or more disaggregated base station units (such as a near real-time (RT) RIC 525 via an E2 link, or a non-RT RIC 515 associated with a service management and orchestration (SMO) Framework 505, or both). A CU 510 may communicate with one or more DUs 530 via respective midhaul links, such as an F1 interface. The DUs 530 may communicate with one or more RUs 540 via respective fronthaul links. The RUs 540 may communicate with respective UEs 104 via one or more radio frequency (RF) access links. In some implementations, the UE 104 may be simultaneously served by multiple RUs 540.

Each of the units, i.e., the CUs 510, the DUs 530, the RUs 540, as well as the near-RT RICs 525, the non-RT RICs 515 and the SMO framework 505, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 510 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 510. The CU 510 may be configured to handle user plane functionality (i.e., central unit-user plane (CU-UP)), control plane functionality (i.e., central unit-control plane (CU-CP)), or a combination thereof. In some implementations, the CU 510 can be logically split into one or more CU-UP units and one or more CU-CP units. The CU-UP unit can communicate bidirectionally with the CU-CP unit via an interface, such as the E1 interface when implemented in an O-RAN configuration. The CU 510 can be implemented to communicate with the DU 530, as necessary, for network control and signaling.

The DU 530 may correspond to a logical unit that includes one or more base station functions to control the operation of one or more RUs 540. In some aspects, the DU 530 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 530 may further host one or more low PHY layers. Each layer (or module) can be implemented with an interface configured to communicate signals with other layers (and modules) hosted by the DU 530, or with the control functions hosted by the CU 510.

Lower-layer functionality can be implemented by one or more RUs 540. In some deployments, an RU 540, controlled by a DU 530, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 540 can be implemented to handle over the air (OTA) communication with one or more UEs 104. In some implementations, real-time and non-real-time aspects of control and user plane communication with the RU(s) 540 can be controlled by the corresponding DU 530. In some scenarios, this configuration can enable the DU(s) 530 and the CU 510 to be implemented in a cloud-based RAN architecture, such as a virtual RAN (vRAN) architecture.

The SMO Framework 505 may be configured to support RAN deployment and provisioning of non-virtualized and virtualized network elements. For non-virtualized network elements, the SMO framework 505 may be configured to support the deployment of dedicated physical resources for RAN coverage requirements, which may be managed via an operations and maintenance interface (such as an O1 interface). For virtualized network elements, the SMO framework 505 may be configured to interact with a cloud computing platform (such as an open cloud (O-cloud) 590) to perform network element life cycle management (such as to instantiate virtualized network elements) via a cloud computing platform interface (such as an O2 interface). Such virtualized network elements can include, but are not limited to, CUs 510, DUs 530, RUs 540 and near-RT RICs 525. In some implementations, the SMO framework 505 can communicate with a hardware aspect of a 4G RAN, such as an open eNB (O-eNB) 511, via an O1 interface. Additionally, in some implementations, the SMO Framework 505 can communicate directly with one or more RUs 540 via an O1 interface. The SMO framework 505 also may include the non-RT RIC 515 configured to support functionality of the SMO Framework 505.

The non-RT RIC 515 may be configured to include a logical function that enables non-real-time control and optimization of RAN elements and resources, artificial intelligence/machine learning (AI/ML) workflows including model training and updates, or policy-based guidance of applications/features in the near-RT RIC 525. The non-RT RIC 515 may be coupled to or communicate with (such as via an A1 interface) the near-RT RIC 525. The near-RT RIC 525 may be configured to include a logical function that enables near-real-time control and optimization of RAN elements and resources via data collection and actions over an interface (such as via an E2 interface) connecting one or more CUs 510, one or more DUs 530, or both, as well as an O-eNB, with the near-RT RIC 525.

In some implementations, to generate AI/ML models to be deployed in the near-RT RIC 525, the non-RT RIC 515 may receive parameters or external enrichment information from external servers. Such information may be utilized by the near-RT RIC 525 and may be received at the SMO Framework 505 or the non-RT RIC 515 from non-network data sources or from network functions. In some examples, the non-RT RIC 515 or the near-RT RIC 525 may be configured to tune RAN behavior or performance. For example, the non-RT RIC 515 may monitor long-term trends and patterns for performance and employ AI/ML models to perform corrective actions through the SMO Framework 505 (such as reconfiguration via 01) or via creation of RAN management policies (such as A1 policies).

### Example Techniques for AN Cancelation via Spatial Processing

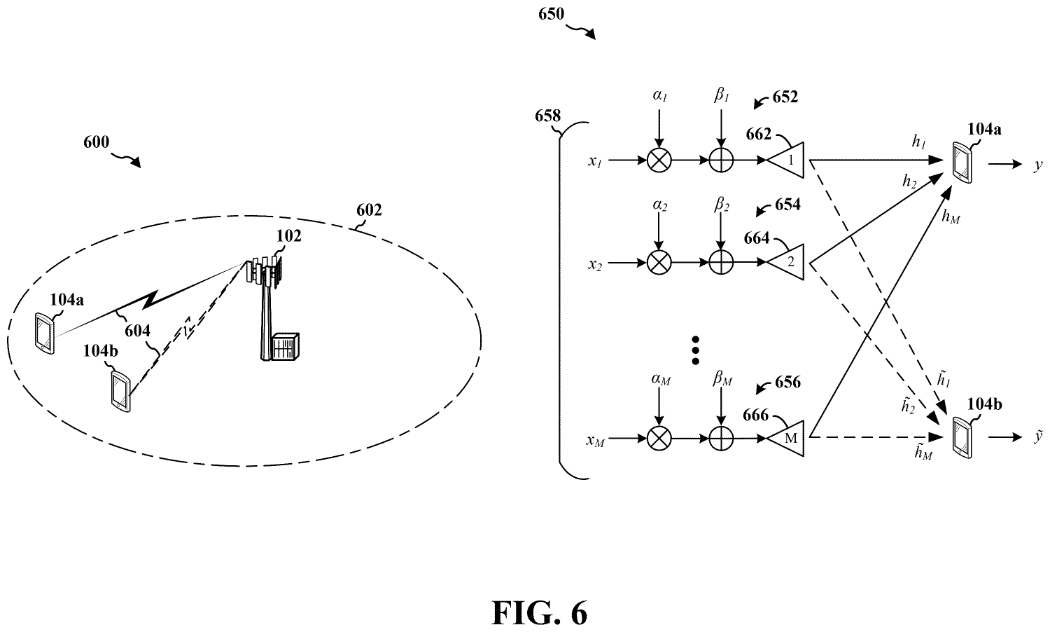

FIG. 6 includes a first diagram illustrating an example RAN 600 including a network node 102, a first UE 104a and a second UE 104b within a cell 602, as well as a second diagram illustrating a conceptual RF front-end 650 of the network node 102 having multiple RF chains 658. It should be noted that in some examples, the network node 102 may be another UE transmitting a sidelink communication.

The signal 604 includes both of: an AN signal generated by the network node 102 based on the CSI of the intended receiver, and a legitimate signal (e.g., an RS, or other physical channel transmission). However, in some examples, the signal 604 may comprise an AN signal without a legitimate signal, as discussed in more detail below. The AN signal and the legitimate signal may added to each other in the power domain, and may be transmitted using the same precoder. The RAN 600 illustrates the network node 102 transmitting a signal 604 to the first UE 104a which is the intended recipient of the signal 604. As used throughout the disclosure, the “power domain” may relate to a transmit power (e.g., total transmit power, nominal transmit power, transmit power allocation, power domain non-orthogonal multiple access (PD-NOMA), etc.) of a transmitter (e.g., from one or more RF chains) to a receiver, and/or as provided in various communication standards (e.g., 3GPP). The second UE 104b is an unintended receiver, but due to its proximity to the first UE 104a, may be capable of also receiving the signal 604. In this example, the intended receiver is a single-antenna receiver.

The network node 102 transmits the signal 604 using multiple RF chains 658 simultaneously. Each RF chain may use a different antenna for transmission of a signal. For example, a first RF chain 652 may use a first antenna 662, a second RF chain 654 may use a second antenna 664, and an Mth RF chain 656 may use a third antenna 666. Each of the antennas 662/664/666 may be associated with a separate antenna port or separate arrays of antenna ports. Each instance of the signal 604 transmitted from an RF chain 658 may include a unique AN signal.

The first RF chain 652 is used to transmit a first legitimate signal (x₁), the second RF chain 654 transmits a second legitimate signal (x₂), and the Mth RF chain 656 transmits an Mth legitimate signal (x_{M}). The legitimate signals (x₁, x₂, and x_{M}) may be the same signal (e.g., multiple copies) or different signals. Each corresponding RF chain may modulate the legitimate signals using a complex transmission coefficient (e.g., α₁, α₂, and α_{M}), and may add an AN (e.g., β₁, β₂, and β_{M}) to each of the legitimate signals. Thus, each instance of β is configured to prevent the unintended receiver from decoding a corresponding legitimate signal (e.g., β₁ protects x₁, β₂ protects x₂, and so on). The complex transmission coefficients (α) may be determined by the network node 102 to optimize detection performance of the intended receiver (e.g., αₘ=hₘ for maximum-ratio-transmission (MRT) for diversity-combining, where x₁=x₂= . . . =xₘ for m=1, 2, . . . , M).

Each RF chain transmits a directed beam (e.g., h₁, h₂, and h_{M}) to the intended receiver. Here, each of h₁, h₂, and h_{M} may be defined as a vector that represents a corresponding antenna port (e.g., a fixed value associated with a corresponding antenna). In other words, each of h₁, h₂, and h_{M} may be a complex coefficient of a beam vector corresponding to a receiving beam of the legitimate receiver. For example, each of h₁, h₂, and h_{M} is a CSI value for a corresponding beam or channel used by the intended receiver for receiving the transmitted signals. In this example, each of h₁, h₂, and h_{M} are directed to a same receiving point of the intended receiver (e.g., the first UE 104a). Each beam (e.g., h₁, h₂, and h_{M}) is used to transmit the legitimate signal and the AN using the same frequency and time resources as used by the other beams. Thus, the RF chains 658 transmit the legitimate signal and the AN simultaneously using the same frequency band. It should be noted however, that because each RF chain transmits the legitimate signal and the AN using a different beam, there is a spatial separation of the transmitted signals.

Accordingly, the signal 604 may be defined as an aggregate of a plurality of signals transmitted by spatially separated antennas or antenna arrays. Because the unintended receiver (e.g., the second UE 104b) is in a different geolocation relative to the intended receiver, each beam is defined by a different complex coefficient (e.g., \tilde{h}₁, \tilde{h}₂, and \tilde{h}_{M}) from the perspective of the unintended receiver relative to the intended receiver.

The network node 102 may generate a unique AN (e.g., β₁, β₂, and β_{M}) for each RF chain based on CSI of the intended receiver. The received legitimate signal (e.g., y) at the intended receiver is defined as the aggregation of the signals transmitted by the RF chains 658. The received signal may be defined according to equation 1 below:

$$y = {h}_{1} ( {α}_{1} {x}_{1} + {β}_{1} ) + {h}_{2} ( {α}_{2} {x}_{2} + {β}_{2} ) + … + {h}_{M} ( {α}_{M} {x}_{M} + {β}_{M} ) + z \qquad Equation 1$$

Thus, a combination of the legitimate signals may be defined as follows:

$${h}_{1} {α}_{1} {x}_{1} + {h}_{2} {α}_{2} {x}_{2} + … + {h}_{M} {α}_{M} {x}_{M} \qquad Equation 2$$

And an aggregation of the AN signals may be defined as:

$${h}_{1} {β}_{1} + {h}_{2} {β}_{2} + … + {h}_{M} {β}_{M} \qquad Equation 3$$

Where z is environmental noise received by the intended receiver.

As discussed, each of β₁, β₂, and β_{M} may be based on CSI of the intended receiver. By configuring the AN in this manner, each instance of an AN signal may cancel out other AN instances. Thus, the network node 102 may compute AN based on the CSI (e.g., hₘ, for m=1, 2, . . . , M) of each beam used for communication with the intended receiver. For example, the AN may be calculated as follows in equation 4 below:

$${h}_{1} {β}_{1} + {h}_{2} {β}_{2} + … + {h}_{M} {β}_{M} = u {\sum }_{n = 1}^{M} {e}^{j θ m} = 0 \qquad Equation 4$$

Where n is an index of a receiving antenna (in this case n=1 because the intended receiver is a single antenna); θ is a phase of each signal transmitted from a corresponding RF chain; and m=1, 2, . . . M. As shown in equation 2, a soft combination of the AN signals results in the AN signals being eliminated at the intended receiver. Thus, the each AN signal (e.g., βₘ) may be based on a corresponding CSI value (e.g., hₘ) as follows:

$${β}_{m} = \frac{{e}^{j θ m}}{{h}_{m}} u , with {θ}_{m} = ( m - 1 ) \frac{2 π}{M} + φ \qquad Equation 5$$

Where μ is a random noise (e.g., a noise kernel) and φ is a rotation such that both u and φ are common for all m. Thus, the network node 102 may adjust a phase and amplitude of μ in order to satisfy equation 2 (e.g., so that the summation of the AN signals equal 0). For example, μ may be determined by the network node 102 to optimize a communication performance metric (e.g., peak-to-average-power ratio (PAPR)). Thus, each of equations 2 and 5 require the transmitter to know the CSI of the receiver.

Note that the aggregated AN signals will not zero-out at the unintended receiver even if the aggregated AN signals are soft combined because hₘ≈\tilde{h}ₘ for any value of m. Moreover, even if the unintended receiver knew the CSI of the intended receiver, the spatial dimensions of \tilde{h}ₘ would prevent the unintended receiver from canceling out the AN signals and recovering the legitimate signals.

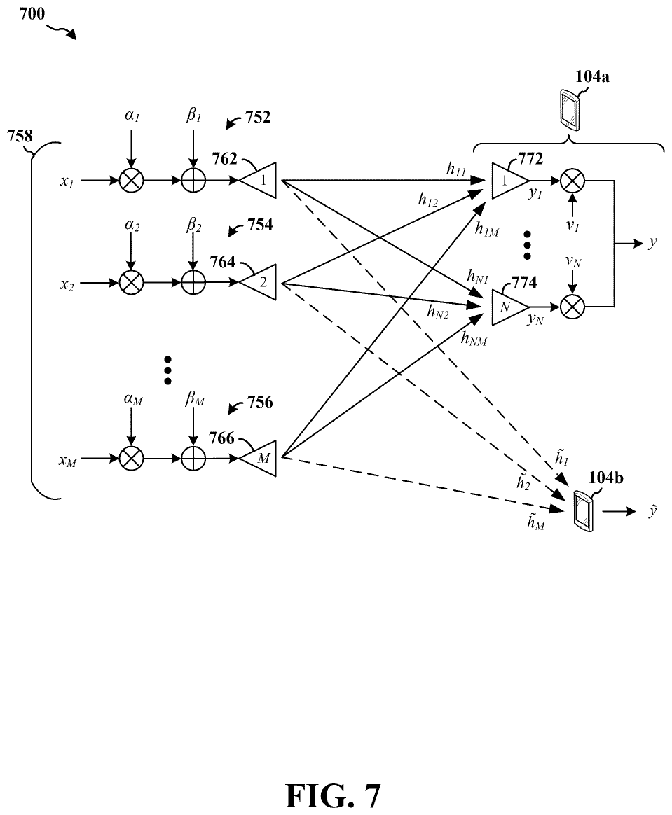

FIG. 7 is a diagram illustrating a conceptual RF front-end 700 of the network node 102 (e.g., the network node of the RAN 600 of FIG. 6), the RF front end 700 having multiple RF chains 758. It should be noted that in some examples, the network node 102 may be another UE transmitting a sidelink communication. Here, the first UE 104a is the intended recipient of a signal (e.g., signal 604 of FIG. 6) transmitted by the network node 102. The second UE 104b is the unintended receiver, but due to its proximity to the first UE 104a, may be capable of also receiving the transmitted signal. In this example, the intended receiver is a multi-antenna receiver.

The network node 102 transmits the signal 604 using multiple RF chains 658 simultaneously. Each RF chain may use a different antenna for transmission of a signal. For example, a first RF chain 652 may use a first antenna 662, a second RF chain 654 may use a second antenna 664, and an Mth RF chain 656 may use a third antenna 666. Each of the antennas 662/664/666 may be associated with a separate antenna port or separate arrays of antenna ports.

The communications and signal processing illustrated in FIG. 7 may be performed as described above in FIG. 6. However, because the intended receiver is a multi-antenna device, the network node 102 may alter the way it transmits the legitimate signal to the intended receiver. As discussed in reference to FIG. 6, the signal 604 is transmitted over a plurality of directed beams to the intended receiver. Because the receiver is a multi-antenna device, the beams used by the network node 102 for transmission are more numerous relative to the beams of FIG. 6. For example, a first RF chain 752 uses a first beam (h₁₁) directed to a first antenna element 772 of the intended receiver, and a second beam (h_{N1}) directed to an Nth antenna element 774 of the intended receiver. A second RF chain 754 uses a third beam (h₁₂) directed to the first antenna element 772, and a fourth beam (h_{N2}) directed to the Nth antenna element 774. An Mth RF chain 756 uses a fifth beam (h_{1M}) directed to the first antenna element 772, and a sixth beam (h_{NM}) directed to the Nth antenna element 774.

As with the network node 102 of FIG. 6, the network node 102 may modulate legitimate signals (e.g., x₁, x₂, x_{M}) by using a complex transmission coefficient (e.g., α₁, α₂, and α_{M}), and may add an AN (e.g., β₁, β₂, and β_{M}) to each of the legitimate signals. The signal 604 is transmitted to the first UE 104a which is the intended recipient of the signal 604. The second UE 104b is an unintended receiver, but due to its proximity to the first UE 104a (e.g., the intended receiver), may be capable of also receiving the signal 604. In this example, the intended receiver is a single-antenna receiver.

The network node 102 transmits the signal 604 using multiple RF chains 658 simultaneously. Each RF chain may use a different antenna for transmission of a signal. For example, a first RF chain 752 may use a first antenna 762, a second RF chain 754 may use a second antenna 764, and an Mth RF chain 756 may use a third antenna 766. Each of the antennas 762/764/766 may be associated with a separate antenna port or separate arrays of antenna ports.

Because the intended receiver is a multi-antenna device, the intended receiver may combine observations from signals received at each antenna (e.g., first antenna element 772 and Nth antenna element 774). FIG. 7 illustrates a first observation (y₁) from the first antenna element 772 and an Nth observation (y_{N}) from the Nth antenna element 774. The observations of each antenna element may be combined using a combining filter coefficient (e.g., v₁ and v_{N}). As such, each of the AN terms (e.g., β₁, β₂, and β_{M}) may be designed and generated based at least in part of the CSI of the intended receiver and the combining filter(s) used by the receiver. For example, the signaling received at the antennas (for n=1, 2, . . . , N, where N is an index of a receiving antenna element) of the intended receiver may be defined as shown in equation 6.

$${y}_{n} = {h}_{n 1} ( {α}_{1} {x}_{1} + {β}_{1} ) + … + {h}_{n M} ( {α}_{M} {x}_{M} + {β}_{M} ) + z \qquad Equation 6$$

If the intended receiver combines the received signals using the filter coefficients (v₁, . . . , v_{N}), then the received legitimate signal (e.g., y) may be defined as shown in equation 7:

$$y = {\sum }_{n = 1}^{N} {v}_{n} {y}_{n} = [ {\sum }_{n = 1}^{N} {\sum }_{m = 1}^{M} {v}_{n} {h}_{m n} {α}_{m} {x}_{m} ] + [ {\sum }_{n = 1}^{N} {\sum }_{m = 1}^{M} {v}_{n} {h}_{m n} {β}_{m} ] \qquad Equation 7$$

Here, the term [Σₙ₌₁^{N} Σₘ₌₁^{M} vₙhₘₙαₘxₘ] represents the combined messages, and the term [Σₙ₌₁^{N} Σₘ₌₁^{M} vₙhₘₙβₘ] represents the aggregated AN. The aggregated AN term may be rearranged and equated to zero as follows in equation 8:

$${β}_{1} {\sum }_{n = 1}^{N} {v}_{n} {h}_{n 1} + … + {β}_{M} {\sum }_{n = 1}^{N} {v}_{n} {h}_{n M} = 0 \qquad Equation 8$$

The aggregated AN term may be rearranged and equated to zero if equation 9 below is satisfied.

$${β}_{m} {\sum }_{n = 1}^{N} {v}_{n} {h}_{n m} = {e}^{j θ m} such that {θ}_{m} = ( m - 1 ) \frac{2 π}{M} + φ \qquad Equation 9$$

As a result, the AN terms may be designed and generated according to equation 10 below:

$${β}_{m} = \frac{{e}^{j θ m}}{{\sum }_{n = 1}^{N} {v}_{n} {h}_{n m}} u \qquad Equation 10$$

In some examples, the network node 102 may configure the first UE 104a (e.g., the intended receiver) to use a single antenna element or multiple antenna elements. If configured to use multiple antenna elements, the first UE 104a may provide the network node 102 with its filter coefficients. The network node 102 may then use the received filter coefficients to generate the AN signals.

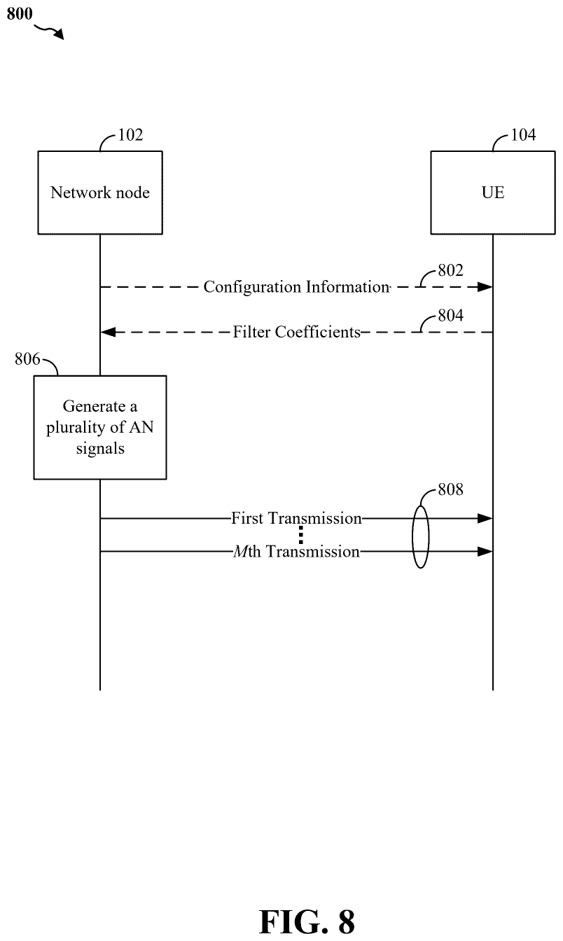

FIG. 8 is a call-flow diagram illustrating example communications and processes 800 performed between a network node 102 and a UE 104 (e.g., intended receiver). As noted above, the network node 102 may also be a UE as part of a sidelink or vehicle-to-everything (V2X) operation.

In a first communication 802, the network node 102 may optionally transmit configuration information to the UE 104. For example, the network node 102 may configure the UE 104 to receive transmitted signals via a single antenna element (e.g., one antenna or one group of antennas) or via multiple antenna elements.

If the network node 102 configured the UE 104 to receive using multiple antenna elements, then the UE 104 may respond to the first communication 802 with a second communication 804 wherein the UE 104 provides the network node 102 with an indication of one or more combining filter coefficients (e.g., vₙ) so that the network node 102 may generate AN signals based on the combining filter coefficients.

At a first process 806, the network node 102 may generate a plurality of AN signals. The AN signals may be generated based on one or more of a CSI of the UE 104 or received combining filter coefficients, depending on whether the UE 104 has been configured to receive transmissions at a single antenna element or multiple antenna elements.

At a third communication 808, the network node 102 may simultaneously transmit multiple signals to the UE 104. Each of the multiple signals may be transmitted over the same frequency but by different beams (e.g., spatially separated transmissions). Each of the multiple signals may include a legitimate signal (x₁, x₂, and x_{M}) modulated using a complex transmission coefficient (e.g., α₁, α₂, and α_{M}) and a unique AN (e.g., β₁, β₂, and β_{M}) added to the power domain of the signal. Here, the legitimate signal may be a reference signal or other information transmitted via a physical channel.

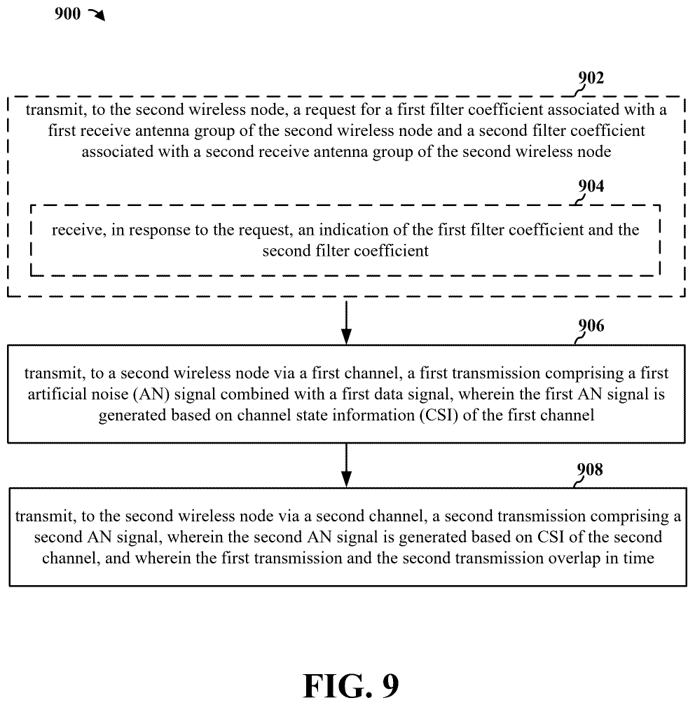

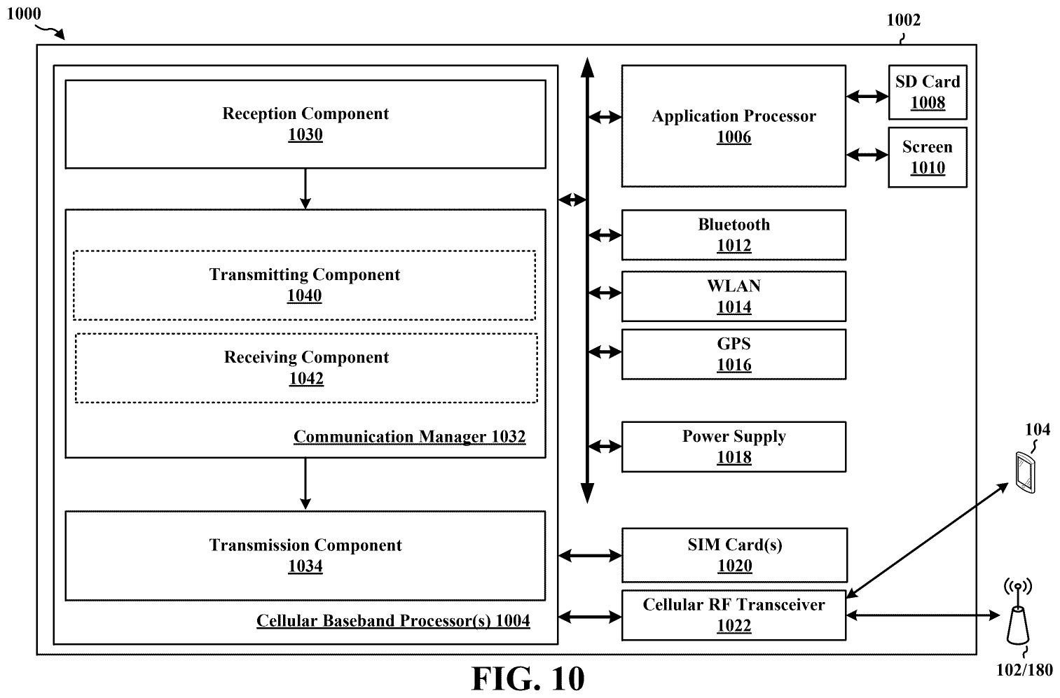

FIG. 9 is a flowchart 900 of a method of wireless communication. The method may be performed by a first wireless node (e.g., the UE 104, network node or base station 102/180 of FIGS. 1 and 3; the apparatus 1002 of FIG. 10). At 902, the first wireless node may optionally transmit, to the second wireless node, a request for a filter coefficient associated with a first receive antenna group of the second wireless node and a second filter coefficient associated with a second receive antenna group of the second wireless node. For example, the first communication 802 of FIG. 8 may include a request for filter coefficients (e.g., combining filter coefficients (vₙ)). Here, if the first communication 802 configures the second wireless node (e.g., UE 104 as illustrated in FIG. 8) to receive transmissions from the first wireless node (e.g., network node 102 as illustrated in FIG. 8), then the second wireless node may treat the first communication 802 as a request for a filter coefficient (e.g., v₁ of FIG. 7) associated with a first receive antenna group (e.g., first antenna element 772 of FIG. 7) of the second wireless node and a second filter coefficient (e.g., v_{N} of FIG. 7) associated with a second receive antenna group (e.g., antenna element 774 of FIG. 7) of the second wireless node.

At 904, the first wireless node may optionally receive, in response to the request, the first filter coefficient and the second filter coefficient. That is, the second wireless node may transmit an indication of the first filter coefficient and the second filter coefficient to the first wireless node, as illustrated in the second communication 804 of FIG. 8. In this manner, the first wireless node may use the filter coefficients to generate and transmit AN signals as described above in relation to FIG. 7.

At 906, the first wireless node may transmit, to a second wireless node via a first channel, a first transmission comprising a first artificial noise (AN) signal combined with a first data signal, wherein the first AN signal is generated based on channel state information (CSI) of the first channel. For example, the first wireless node may generate a first AN signal (e.g., β₁ of FIGS. 6 or 7) based on CSI of a channel or beam (e.g., h₁ of FIGS. 6 or 7) used for communication with the second wireless node. The first AN signal may be generated as described above in reference to FIGS. 6 or 7. The first wireless node may also combine the first AN signal in the power domain with a first data signal (e.g., legitimate signal x₁ of FIGS. 6 or 7), then transmit the combined signals over the channel or beam.

At 908, the first wireless node may transmit, to the second wireless node via a second channel, a second transmission comprising a second AN signal, wherein the second AN signal is generated based on CSI of the second channel, and wherein the first transmission and the second transmission overlap in time. For example, the first wireless node may generate a second AN signal (e.g., β₂ of FIGS. 6 or 7) based on CSI of another channel or beam (e.g., h₂ of FIGS. 6 or 7) used for communication with the second wireless node. The second AN signal may be generated as described above in reference to FIGS. 6 or 7. The first wireless node may also combine the second AN signal in the power domain with a second data signal (e.g., legitimate signal x₂ of FIGS. 6 or 7), then transmit the combined signals over the other channel or beam. It should be noted that the first transmission and the second transmission may be transmitted simultaneously, such that the transmissions overlap in time. The two transmissions may also be transmitted over the same frequency band.

In certain aspects, the first transmission is transmitted via a first antenna group comprising one or more first antenna elements, and wherein the second transmission is transmitted via a second antenna group comprising one or more second antenna elements. For example, one or more of the first antenna group (e.g., first antenna 662/762 of FIGS. 6 or 7) and the second antenna group (e.g., second antenna 664/764 of FIGS. 6 or 7) may include one or more antennas. The one or more antennas of the first group may be separate from the antennas of the second group. Accordingly, in some examples, the first wireless node may transmit the first transmission and the second transmission using one or more antennas.

In certain aspects, the first AN and the second AN are further generated based on a quantity of antenna groups used for transmission of the first transmission and the second transmission. For example, as discussed above in reference to FIGS. 6 and 7, a phase (θ) of each signal transmitted from the first wireless node may be determined based on a quantity of antenna groups (e.g., M) of the equation:

$${θ}_{m} = ( m - 1 ) \frac{2 π}{M} + φ .$$

In certain aspects, the first AN signal is further generated based on the first filter coefficient, and the second AN signal is further generated based on the second filter coefficient. For example, as discussed above in reference to FIG. 7, each AN is based on CSI of a corresponding channel or beam, and a filter coefficient of a corresponding antenna of a second wireless node configured to receive the first transmission and the second transmission as a multi-antenna receiver.

In certain aspects, the first transmission is transmitted via a first beam, and the second transmission is transmitted via a second beam. That is, the first transmission is transmitted using a first beam, and the second transmission is transmitted using a second beam separate from the first beam. Because each of the beams is transmitted using a separate antenna, the beams do not share a same spatial location.

In certain aspects, the second AN signal is combined with one of the first data signal or a second data signal. For example, the first transmission may include a combination of a first data signal (x₁) and a first AN signal (β₁), but the second transmission may include a second AN signal (β₂) without a corresponding data signal. In such an example, the aggregate transmission power of the AN signals may improve the cover of the first data signal. Alternatively, in some examples, the second transmission may include the first data signal or a second data signal. Specifically, the first wireless node may simultaneously transmit multiple copies of the same data signal from separate antenna groups, wherein each copy of the data signal is combined with a different AN signal relative to AN signal(s) used by other antenna groups. Or, the first wireless node may simultaneously transmit multiple different data signals from separate antenna groups, wherein each unique data signal is combined with a different AN signal relative to AN signal(s) used by other antenna groups.

In certain aspects, the first transmission is defined by a power-domain ratio between the first AN signal and the first data signal, and wherein the power-domain ratio is based on at least one of a quality of service (QoS) of the second wireless node or an indicator of channel quality (CQI) of the first channel. Here, the first wireless node may determine a transmission power ratio for an AN signal and a data signal. For example, the first wireless node may determine a first power to use to transmit the first AN signal and a second power to use to transmit the first data signal. The ratio may take into account transmission power limits of the first wireless node, as well as performance metrics of the second wireless node. The performance metrics may be defined by one or more of a QoS of a CQI of the second wireless node.

In certain aspects, the first transmission is transmitted via a first frequency, and the second transmission is transmitted via the first frequency. In other words, the two transmissions may be transmitted over the same frequency band.

FIG. 10 is a diagram 1000 illustrating an example of a hardware implementation for an apparatus 1002. The apparatus 1002 may be configured as a network node or a UE, and includes one or more cellular baseband processors 1004 (also referred to as a modem) coupled to a cellular RF transceiver 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018.

The one or more cellular baseband processors 1004 communicate through the cellular RF transceiver 1022 with the UE 104 and/or BS 102/180. The one or more cellular baseband processors 1004 may each include a computer-readable medium/one or more memories. The computer-readable medium/one or more memories may be non-transitory. The one or more cellular baseband processors 1004 are responsible for general processing, including the execution of software stored on the computer-readable medium/one or more memories individually or in combination. The software, when executed by the one or more cellular baseband processors 1004, causes the one or more cellular baseband processors 1004 to, individually or in combination, perform the various functions described supra. The computer-readable medium/one or more memories may also be used individually or in combination for storing data that is manipulated by the one or more cellular baseband processors 1004 when executing software. The one or more cellular baseband processors 1004 individually or in combination further include a reception component 1030, a communication manager 1032, and a transmission component 1034. The communication manager 1032 includes the one or more illustrated components. The components within the communication manager 1032 may be stored in the computer-readable medium/one or more memories and/or configured as hardware within the one or more cellular baseband processors 1004. In one configuration, the one or more cellular baseband processors 1004 may be components of the UE 104 and may individually or in combination include the one or more memories 360 and/or at least one of the one or more TX processors 368, at least one of the one or more RX processors 356, and at least one of the one or more controllers/processors 359. In one configuration, the apparatus 1002 may be a modem chip and include just the one or more baseband processors 1004, and in another configuration, the apparatus 1002 may be the entire UE (e.g., 104 of FIGS. 1 and 3) and include the aforediscussed additional modules of the apparatus 1002. In one configuration, the baseband unit 1004 may be a component of the BS 102/180 and may include the one or more memories 376 and/or at least one of the one or more TX processors 316, at least one of the one or more RX processors 370, and at least one of the one or more controllers/processors 375.

The communication manager 1032 includes a transmitting component 1040 that is configured to transmit, to the second wireless node, a request for a first filter coefficient associated with a first receive antenna group of the second wireless node and a second filter coefficient associated with a second receive antenna group of the second wireless node; transmit, to a second wireless node via a first channel, a first transmission comprising a first artificial noise (AN) signal combined with a first data signal, wherein the first AN signal is generated based on channel state information (CSI) of the first channel; and transmit, to the second wireless node via a second channel, a second transmission comprising a second AN signal, wherein the second AN signal is generated based on CSI of the second channel, and wherein the first transmission and the second transmission overlap in time; e.g., as described in connection with 902, 906, and 908 of FIG. 9.

The communication manager 1032 further includes a receiving component 1042 configured to receive, in response to the request, an indication of the first filter coefficient and the second filter coefficient, e.g., as described in connection with 904 of FIG. 9.

The apparatus may include additional components that perform each of the blocks of the algorithm in the aforementioned flowchart of FIG. 9. As such, each block in the aforementioned flowchart may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1002, and in particular the one or more cellular baseband processors 1004, includes means for transmitting, to the second wireless node, a request for a first filter coefficient associated with a first receive antenna group of the second wireless node and a second filter coefficient associated with a second receive antenna group of the second wireless node; means for receiving, in response to the request, an indication of the first filter coefficient and the second filter coefficient; means for transmitting, to a second wireless node via a first channel, a first transmission comprising a first artificial noise (AN) signal combined with a first data signal, wherein the first AN signal is generated based on channel state information (CSI) of the first channel; and means for transmitting, to the second wireless node via a second channel, a second transmission comprising a second AN signal, wherein the second AN signal is generated based on CSI of the second channel, and wherein the first transmission and the second transmission overlap in time.

The aforementioned means may be one or more of the aforementioned components of the apparatus 1002 configured to perform the functions recited by the aforementioned means. As described supra, the apparatus 1002 may include the one or more TX Processors 368, the one or more RX Processors 356, and the one or more controllers/processors 359; or the one or more memories 376 and/or at least one of the one or more TX Processors 316, the one or more RX Processors 370, and the one or more controllers/processors 375. As such, in one configuration, the aforementioned means may be the one or more TX Processors 368, the one or more RX Processors 356, and the one or more controllers/processors 359; or the one or more memories 376 and/or at least one of the one or more TX Processors 316, the one or more RX Processors 370, and the one or more controllers/processors 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

### Additional Considerations

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

### EXAMPLE ASPECTS

The following examples are illustrative only and may be combined with aspects of other embodiments or teachings described herein, without limitation.

Example 1 is a method for wireless communication by a first wireless node, comprising: transmitting, to a second wireless node via a first channel, a first transmission comprising a first artificial noise (AN) signal combined with a first data signal, wherein the first AN signal is generated based on channel state information (CSI) of the first channel; and transmitting, to the second wireless node via a second channel, a second transmission comprising a second AN signal, wherein the second AN signal is generated based on CSI of the second channel, and wherein the first transmission and the second transmission overlap in time.

Example 2 is the method of example 1, wherein the first transmission is transmitted via a first antenna group comprising one or more first antenna elements, and wherein the second transmission is transmitted via a second antenna group comprising one or more second antenna elements.

Example 3 is the method of any of examples 1 and 2, wherein the first AN and the second AN are further generated based on a quantity of antenna groups used for transmission of the first transmission and the second transmission.

Example 4 is the method of any of examples 1-3, further comprising: transmitting, to the second wireless node, a request for a first filter coefficient associated with a first receive antenna group of the second wireless node and a second filter coefficient associated with a second receive antenna group of the second wireless node; and receiving, in response to the request, an indication of the first filter coefficient and the second filter coefficient.

Example 5 is the method of example 4, wherein the first AN signal is further generated based on the first filter coefficient, and wherein the second AN signal is further generated based on the second filter coefficient.

Example 6 is the method of any of examples 1-5, wherein the first transmission is transmitted via a first beam, and wherein the second transmission is transmitted via a second beam.

Example 7 is the method of any of examples 1-6, wherein the second AN signal is combined with one of the first data signal or a second data signal.

Example 8 is the method of any of examples 1-7, wherein the first transmission is defined by a power-domain ratio between the first AN signal and the first data signal, and wherein the power-domain ratio is based on at least one of a quality of service (QoS) of the second wireless node or an indicator of channel quality (CQI) of the first channel.

Example 9 is the method of any of examples 1-8, wherein the first transmission is transmitted via a first frequency, and wherein the second transmission is transmitted via the first frequency.

Example 10 is a first wireless node comprising: one or more memories; and one or more processors each communicatively coupled with at least one of the one or more memories, the one or more processors, individually or in any combination, operable to cause the first wireless node to perform the method of any of examples 1-9.

Example 11 is the first wireless node of example 10, wherein the first wireless node is configured as a user equipment (US) or a network node.

Example 12 is a first wireless node comprising one or more means for performing the method of any of claims 1-9.

Example 13 is the first wireless node of example 12, wherein the first wireless node is configured as a user equipment (US) or a network node.

Example 14 is one or more non-transitory computer-readable storage media having instructions stored thereon that, when executed by one or more processors of a first wireless node, cause the one or more processors of the first wireless node to perform the method of any of claims 1-9 for wireless communication by a first wireless node.

Example 15 is the one or more non-transitory computer-readable storage media of example 14, wherein the first wireless node is configured as a user equipment (US) or a network node.

What is claimed is:

1. A first wireless node configured for wireless communication, comprising:
one or more memories; and one or more processors each communicatively coupled with at least one of the one or more memories, the one or more processors, individually or in any combination, operable to cause the first wireless node to:
transmit, to a second wireless node via a first channel, a first transmission comprising a first artificial noise (AN) signal combined with a first data signal, wherein the first AN signal is generated based on channel state information (CSI) of the first channel; and
transmit, to the second wireless node via a second channel, a second transmission comprising a second AN signal, wherein the second AN signal is generated based on CSI of the second channel, and wherein the first transmission and the second transmission overlap in time.

2. The first wireless node of claim 1, wherein the first transmission is transmitted via a first antenna group comprising one or more first antenna elements, and wherein the second transmission is transmitted via a second antenna group comprising one or more second antenna elements.

3. The first wireless node of claim 2, wherein the first AN and the second AN are further generated based on a quantity of antenna groups used for transmission of the first transmission and the second transmission.

4. The first wireless node of claim 1, wherein the one or more processors, individually or in combination, are further operable to cause the first wireless node to:
transmit, to the second wireless node, a request for a first filter coefficient associated with a first receive antenna group of the second wireless node and a second filter coefficient associated with a second receive antenna group of the second wireless node; and
receive, in response to the request, an indication of the first filter coefficient and the second filter coefficient.

5. The first wireless node of claim 4, wherein the first AN signal is further generated based on the first filter coefficient, and wherein the second AN signal is further generated based on the second filter coefficient.

6. The first wireless node of claim 1, wherein the first transmission is transmitted via a first beam, and wherein the second transmission is transmitted via a second beam.

7. The first wireless node of claim 1, wherein the second AN signal is combined with one of the first data signal or a second data signal.

8. The first wireless node of claim 1, wherein the first transmission is defined by a power-domain ratio between the first AN signal and the first data signal, and wherein the power-domain ratio is based on at least one of a quality of service (QoS) of the second wireless node or an indicator of channel quality (CQI) of the first channel.

9. The first wireless node of claim 1, wherein the first transmission is transmitted via a first frequency, and wherein the second transmission is transmitted via the first frequency.

10. A method for wireless communication by a first wireless node, comprising:
transmitting, to a second wireless node via a first channel, a first transmission comprising a first artificial noise (AN) signal combined with a first data signal, wherein the first AN signal is generated based on channel state information (CSI) of the first channel; and
transmitting, to the second wireless node via a second channel, a second transmission comprising a second AN signal, wherein the second AN signal is generated based on CSI of the second channel, and wherein the first transmission and the second transmission overlap in time.

11. The method of claim 10, wherein the first transmission is transmitted via a first antenna group comprising one or more first antenna elements, and wherein the second transmission is transmitted via a second antenna group comprising one or more second antenna elements.

12. The method of claim 11, wherein the first AN and the second AN are further generated based on a quantity of antenna groups used for transmission of the first transmission and the second transmission.

13. The method of claim 10, further comprising:
transmitting, to the second wireless node, a request for a first filter coefficient associated with a first receive antenna group of the second wireless node and a second filter coefficient associated with a second receive antenna group of the second wireless node; and
receiving, in response to the request, an indication of the first filter coefficient and the second filter coefficient.

14. The method of claim 13, wherein the first AN signal is further generated based on the first filter coefficient, and wherein the second AN signal is further generated based on the second filter coefficient.

15. The method of claim 10, wherein the first transmission is transmitted via a first beam, and wherein the second transmission is transmitted via a second beam.

16. The method of claim 10, wherein the second AN signal is combined with one of the first data signal or a second data signal.

17. The method of claim 10, wherein the first transmission is defined by a power-domain ratio between the first AN signal and the first data signal, and wherein the power-domain ratio is based on at least one of a quality of service (QoS) of the second wireless node or an indicator of channel quality (CQI) of the first channel.

18. The method of claim 10, wherein the first transmission is transmitted via a first frequency, and wherein the second transmission is transmitted via the first frequency.

19. One or more non-transitory computer-readable media having instructions stored thereon that, when executed by one or more processors of a first wireless node, cause the one or more processors of the first wireless node to perform operations comprising:
transmitting, to a second wireless node via a first channel, a first transmission comprising a first artificial noise (AN) signal combined with a first data signal, wherein the first AN signal is generated based on channel state information (CSI) of the first channel; and
transmitting, to the second wireless node via a second channel, a second transmission comprising a second AN signal, wherein the second AN signal is generated based on CSI of the second channel, and wherein the first transmission and the second transmission overlap in time.

20. The one or more non-transitory computer-readable media of claim 19, wherein the operations further comprise:
transmitting, to the second wireless node, a request for a first filter coefficient associated with a first receive antenna group of the second wireless node and a second filter coefficient associated with a second receive antenna group of the second wireless node; and
receiving, in response to the request, an indication of the first filter coefficient and the second filter coefficient.

21. The one or more non-transitory computer-readable media of claim 20, wherein the first AN signal is further generated based on the first filter coefficient, and wherein the second AN signal is further generated based on the second filter coefficient.
